(19) United States
(12) Patent Application Publication
(10) Pub. No.: US 2002/0172125 A1
(43) Pub. Date: Nov. 21, 2002

(54) Protection method for manual ejection operation of optical disk driver

(76) Inventors: Cheng-Yao Liao, Taipei (TW); Ching Ho Huang, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 09/858,605

(22) Filed: May 17, 2001

(51) Int. Cl. G11B 33/02

(52) U.S. Cl. 369/75.2

(57) ABSTRACT

A protection method for manual ejection operation of optical disk driver is proposed. The method sets the tray of the optical disk driver to a locked state when the optical disk driver is in normal rotation. The state of a load-sensing switch is on when the tray is in state of disk loading. When a manual ejection is triggered, the state of a load-sensing switch is off and a controller senses the off state. The controller applies a voltage to the tray motor and change the state of the load-sensing switch to on state. Therefore, the tray of an optical disk driver is set to a locked state.

### FIELD OF THE INVENTION

The present invention relates to a protection method for manual ejection operation of optical disk driver, especially to a protection method for optical disk driver to prevent the careless manual ejection operation during high-speed rotation of the optical disk driver.

### BACKGROUND OF THE INVENTION

The optical disk driver generally has a transmission system to load and eject the optical disk. Moreover, the optical disk driver generally has manual ejection or emergency ejection function to eject an optical disk 2a from the optical disk driver 1a when the optical disk driver 1a is malfunctioned or not powered. As shown in FIGS. 1A and 1B, the panel 4a of the optical disk driver 1a has a round opening 5a thereon. The user can use a slim bar 3a inserting into the round opening 5a to cancel the load-locking function of the optical disk driver 1a such that the tray 6a can be forced to eject from the optical disk driver 1a and the optical disk 2a can be removed.

However, in the above-mentioned optical disk driver 1a, the manual ejection operation can be executed at any time even the optical disk driver 1a is in high speed rotation. If the optical disk driver 1a is in high speed rotation and the user careless or curiously inserts a slim bar 3a inserting into the round opening 5a, the tray 6a is still forced to eject from the optical disk driver 1a. Therefore, the optical disk driver 1a has the risk to damage.

### SUMMARY OF THE INVENTION

It is the object of the present invention to provide a protection method for optical disk driver to prevent the careless manual ejection operation during high-speed rotation of the optical disk driver.

To achieve above object, the present invention provides a protection method for manual ejection operation of optical disk driver. The method sets the tray of the optical disk driver to a locked state when the optical disk driver is in normal rotation. The state of a load-sensing switch is on when the tray is in state of disk loading. When a manual ejection is triggered, the state of a load-sensing switch is off and a controller senses the off state. The controller applies a voltage to the tray motor and change the state of the load-sensing switch to on state. Therefore, the tray of an optical disk driver is set to a locked state.

The various objects and advantages of the present invention will be more readily understood from the following detailed description when read in conjunction with the appended drawing, in which:

### BRIEF DESCRIPTION OF DRAWING

FIG. 1A shows the perspective view of prior art optical disk driver before manual ejection;

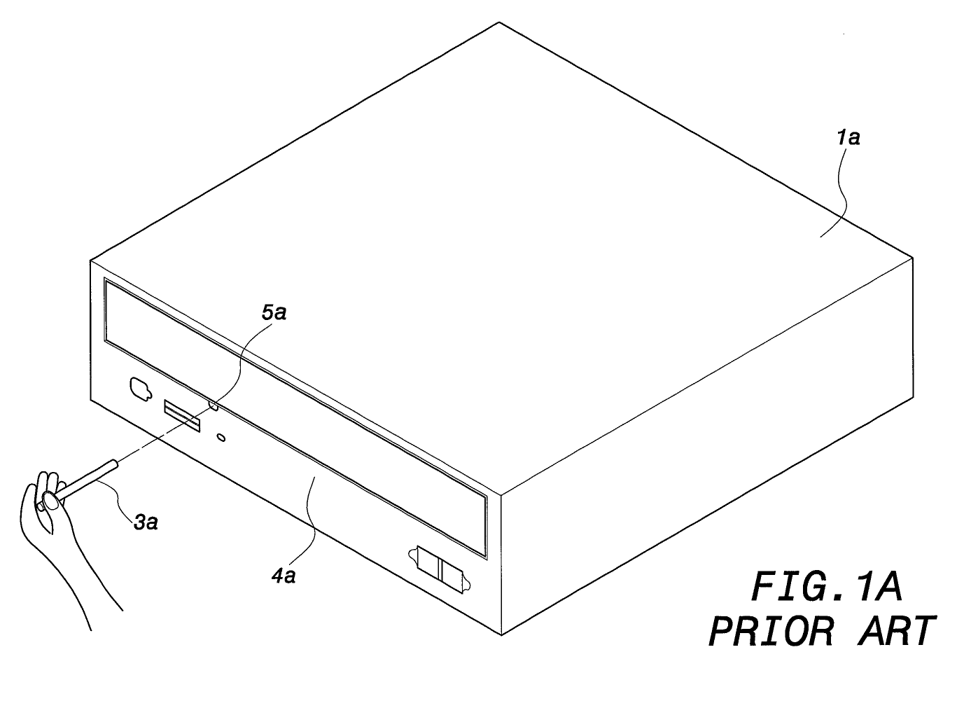

FIG. 1B shows the perspective view of prior art optical disk driver after manual ejection;

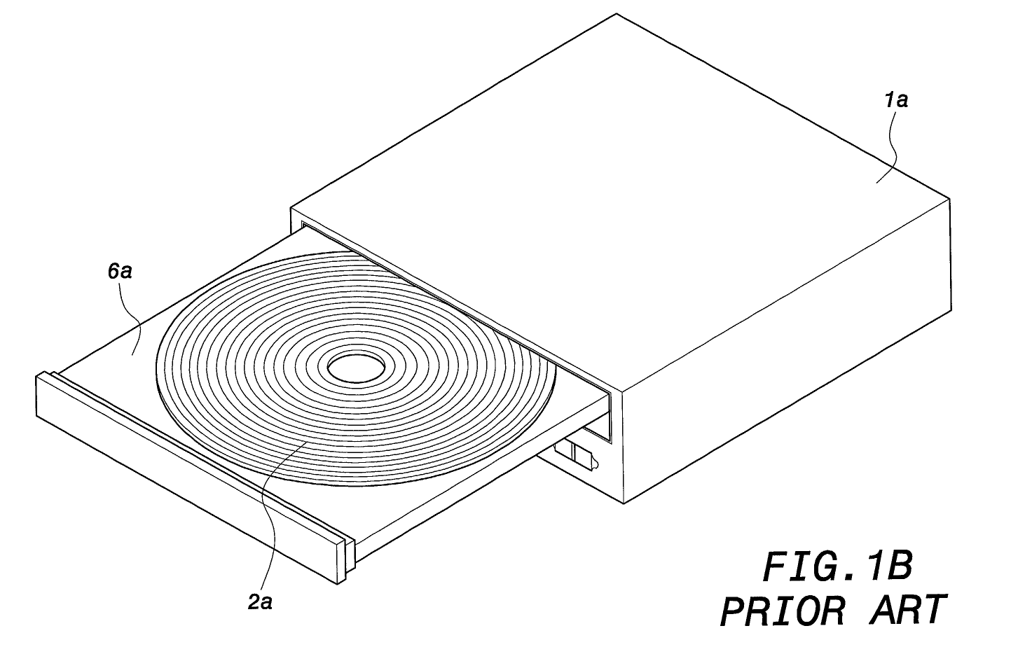

FIG. 2 shows a perspective view of an optical disk driver for demonstrating the protection method; and

FIG. 3 shows the flowchart of the protection method for manual ejection operation of optical disk driver.

### DETAILED DESCRIPTION OF THE INVENTION

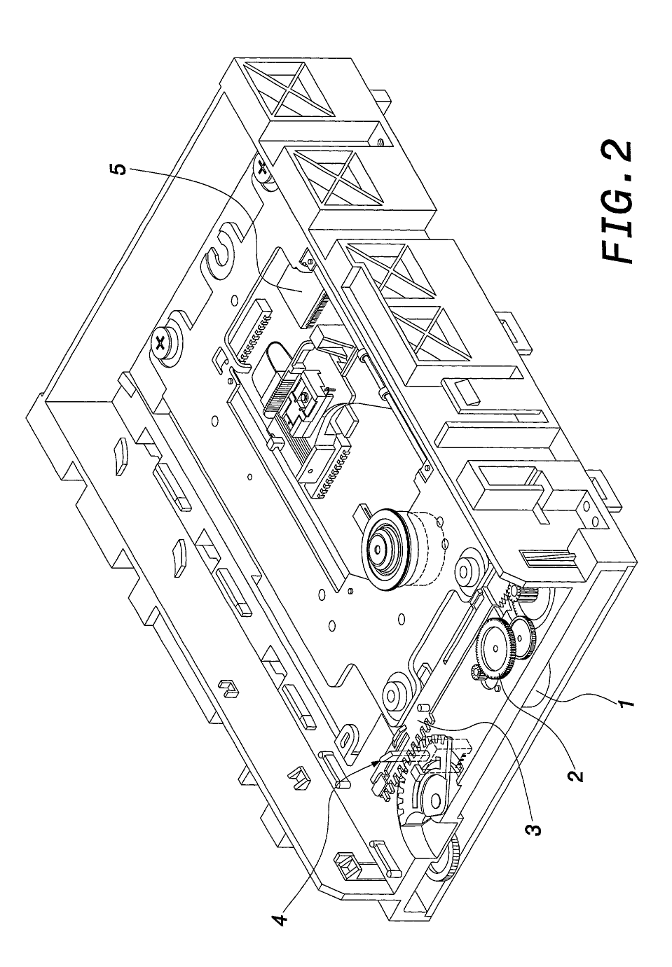

FIG. 2 shows a perspective view of an optical disk driver for demonstrating the protection method for manual ejection operation of optical disk drive according to the present invention. The tray of the optical disk driver is driven by a tray motor 1 through a transmission mechanism composed of a gear 2 and rack 3. The disk-loading state is detected by a load-sensing switch 4. Moreover, the present invention provides a controller 5 to sense the on/off state of the load-sensing switch 4 and provides a voltage of specific level to the tray motor 1.

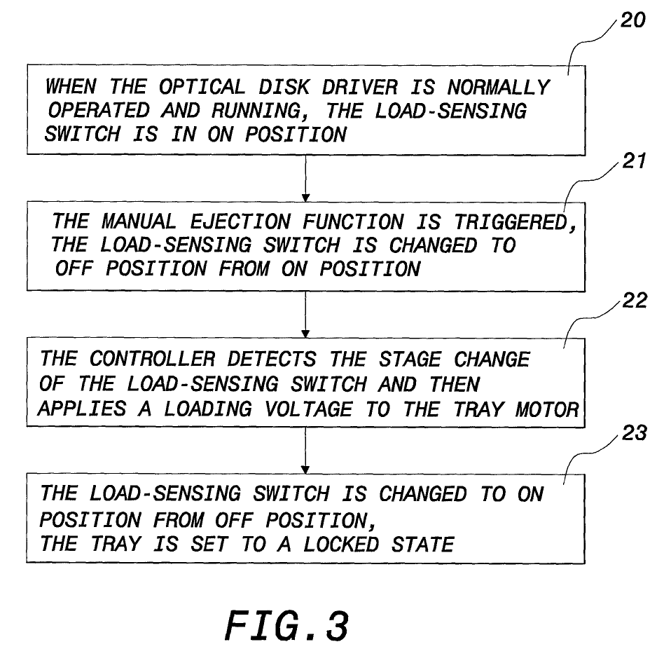

As shown in FIG. 3, when the optical disk driver is normally operated and running, the disk tray of the optical disk driver is in load-locked state, i.e., the tray cannot be ejected by pressing the ejection button. At this time, the load-sensing switch 4 is in on position in step 20. In the present invention, the load-sensing switch is used as judgment reference for the controller 5. If the optical disk driver is normally operated and running, and the manual ejection function is triggered, i.e., the load-locked state is relieved, the load-sensing switch is changed to off position from on position in step 21. The controller 5 detects the stage change of the load-sensing switch 4 and then applies a loading voltage to the tray motor 1 in step 22. At this time, the load-sensing switch is changed to on position from off position, the tray is set to a locked state in step 23. Therefore, the present invention can prevent the damage of optical disk driver and optical disk due to careless activating manual ejection when the optical disk driver is in high-speed running.

Although the present invention has been described with reference to the preferred embodiment thereof, it will be understood that the invention is not limited to the details thereof. Various substitutions and modifications have suggested in the foregoing description, and other will occur to those of ordinary skill in the art. Therefore, all such substitutions and modifications are intended to be embraced within the scope of the invention as defined in the appended claims.

I claim

1. A protection method for manual ejection operation of optical disk driver; the method setting the tray of the optical disk driver to a locked state when the optical disk driver is in normal rotation; the method having following steps:
(a) a controller sensing the state of a load-sensing switch of the optical disk driver; the state being on when the optical disk is loaded and off when the optical disk is not loaded;
(b) the state of a load-sensing switch being changed to off state when a manual ejection operation of the optical disk driver is activated;
(c) the controller sensing the off state of the load-sensing switch and applied a disk-loading voltage to a tray motor of the optical disk driver; the state of a load-sensing switch being changed to on state from off state and the tray of an optical disk driver being set to a locked state.

2. The protection method for manual ejection operation of optical disk driver as in claim 1, wherein in step (b), the manual ejection operation is performed by inserting a slim bar into a round opening on a panel of the optical disk driver.
